(19) United States
(12) Patent Application Publication
(10) Pub. No.: US 2024/0181949 A1
(43) Pub. Date: Jun. 6, 2024

(54) ARRANGEMENT COMPRISING A MOTOR VEHICLE AND A TRANSPORT APPARATUS ATTACHABLE ON SAID MOTOR VEHICLE

(71) Applicant: Dr. Ing. h.c. F. Porsche Aktiengesellschaft, Stuttgart (DE)

(72) Inventor: Peter Baur, Moensheim (DE)

(21) Appl. No.: 18/520,950

(22) Filed: Nov. 28, 2023

(30) Foreign Application Priority Data
Dec. 5, 2022 (DE) 10 2022 132 185.1

(51) Int. Cl. B60P 1/02

(52) U.S. Cl. CPC B60P 1/022

(57) ABSTRACT

An arrangement includes a motor vehicle (12) and a transport apparatus (20) attachable on the motor vehicle (12). The transport apparatus (20) has a sensor apparatus (48) connected to a control unit (54) that is connected to a motor vehicle control unit (30) in a signal-related manner. The sensor apparatus (48) and the control unit (54) are designed such that the sensor apparatus (48) acquires at least one state variable of the transport apparatus (20) in its attached state on the motor vehicle (12), and the at least one acquired state variable is monitored by the control unit (54) with respect to an attachment-critical and/or loading-critical state of the transport apparatus (20).

### CROSS REFERENCE TO RELATED APPLICATION

This application claims priority on German Patent Application No 10 2022 132 185.1 filed Dec. 5, 2022, the entire disclosure of which is incorporated herein by reference.

### BACKGROUND

### Field of the Invention

The invention relates to an arrangement comprising a motor vehicle and a transport apparatus attachable on the motor vehicle.

### Related Art

The prior art includes arrangements of a motor vehicle and a transport apparatus such as a bicycle rack or a transport container that is attachable to a trailer hitch, or directly on a rear cross member or lift gate of the motor vehicle. The transport apparatus also can be a trailer that is attached to the motor vehicle via a trailer hitch or a transport unit attached on a roof rack or another location on the motor vehicle. A transport apparatus in the form of a bicycle rack is shown in DE 10 2020 128 870 A1.

A problem with such transport apparatuses is that attaching the transport apparatuses on the motor vehicle and loading the transport apparatuses with objects, such as loading a bicycle on a bicycle rack, is based solely on user experience. Incorrect attachment and/or loading may not be noticeable when the vehicle is stationary, but such incorrect attachment and/or loading could cause the transport apparatus to come loose when the motor vehicle is moving, thereby increasing a risk of injury for the vehicle occupants and other road users. A dangerous situation also could arise with proper attachment and loading if the transport apparatus has a defect and/or if high wind loads are acting on the transport apparatus and the driver does not notice, or notices too late, because transport apparatuses, particularly transport apparatuses positioned in the rear region or on the roof, are poorly visible from the interior of the motor vehicle. Thus, abnormalities on the transport apparatus are not noticeable or are noticeable only to a very limited extent while driving.

The object of the invention is to provide a simple arrangement comprising a motor vehicle and a transport apparatus that is attachable on the motor vehicle in a manner that reduces a risk of injury for the vehicle occupants and other road users.

### SUMMARY OF THE INVENTION

The transport apparatus disclosed herein comprises a sensor apparatus connected to a control unit that is connected in a signal-related manner to a motor vehicle control unit. The sensor apparatus and the control unit are designed such that the sensor apparatus acquires at least one state variable of the transport apparatus in its attached state on the motor vehicle and the at least one acquired state variable is monitored by the control unit with respect to an attachment-critical and/or loading-critical state of the transport apparatus, in particular when the motor vehicle is driving. Thus, the sensor apparatus and the control unit reliably detect improper attachment and/or overloading, i.e., loading in excess of a permissible maximum weight, of the transport apparatus and a defect of the transport apparatus that is critical when driving. This can significantly reduce the risk of injury for the vehicle occupants and other road users caused by the transport apparatus. External stress and loading of the transport apparatus on the motor vehicle can be monitored by the sensor apparatus and the control unit. Abnormalities relating to attachment, loading and stress cause a warning to be issued to the driver, for instance via a user interface (e.g. a display) arranged in the passenger compartment. The warning can be issued while driving and also when the vehicle is stationary, such as when the transport apparatus is being attached and loaded. Thus, the driver can be informed of incorrect attachment and loading before driving and can make appropriate adjustments. Otherwise, the driver can be notified of a defect of the transport apparatus while driving, for example, in which case the driver would have to interrupt driving.

The transport apparatus can be connected in a signal-related manner to the motor vehicle via a cable. Connection via a cable is particularly reliable and makes it possible to provide a continuous, reliable monitoring of the transport apparatus. The wired connection can be implemented via a signal interface that may already be available on the motor vehicle via a trailer hitch. Alternatively, or additionally, the transport apparatus may comprise a vehicle communication module that can be connected wirelessly to a counter communication module arranged on the motor vehicle. The wireless connection, e.g. via WLAN or Bluetooth, between the vehicle communication module and the counter communication module can be established easily. The transport apparatus thus can be positioned anywhere on the motor vehicle. The exchange can be encrypted so that the information cannot be intercepted and potentially manipulated by unauthorized third parties. Alternatively, the transfer of information could be unencrypted.

The control unit of some embodiments is arranged on the transport apparatus, such that the control unit only takes on tasks related to the transport apparatus. Coupling the control unit to the motor vehicle control unit enables predefined information, such as information from the sensor apparatus, to be transmitted to the motor vehicle control unit, and corresponding measures, such as warnings, are triggered by the motor vehicle control unit as a function of the information from the sensor apparatus. The control unit in this case is used to process and evaluate the raw data from the sensor apparatus. The motor vehicle control unit is used only to trigger the corresponding actions based on the information transmitted by the control unit.

In one embodiment, the control unit is integrated into a motor vehicle control unit. Thus, the transport apparatus has fewer components and a lower weight. The reduced weight is important if the transport apparatus has to be attached on the motor vehicle using the muscle power of one or more people.

The transport apparatus of some embodiments is connectable electrically to an electrical system of the motor vehicle. Thus, there is no need for a separate power source, i.e. a battery, on the transport apparatus and the weight of the transport apparatus can be reduced. This also provides a reliable supply of electrical energy to the transport apparatus and reduces the risk of an unwanted failure of the transport apparatus due to a depleted battery.

The transport apparatus of some embodiments has a battery that is connected electrically to the sensor apparatus. The transport apparatus that has a wireless connection between the vehicle communication module and the counter communication module is self-sufficient and can be positioned anywhere on the motor vehicle. The battery also can be connectable to the vehicle electrical system of the motor vehicle so that the battery can be charged via the vehicle electrical system.

The sensor apparatus of some embodiments has an acceleration sensor for detecting vibrations of the transport apparatus and/or a loading sensor. The sensor signal of the acceleration sensor may be compared continuously to a vibration threshold value that is stored in the control unit. If the sensor signal exceeds the vibration threshold value, the control unit transmits a corresponding command to the motor vehicle control unit and the motor vehicle control unit triggers a corresponding measure. The acceleration sensor is relevant for monitoring the transport apparatus when the motor vehicle is driving. Impermissible vibrations can be caused by a defect in the transport apparatus, uneven road surfaces or wind loads. The acceleration sensor can be a single-axis or a multi-axis acceleration sensor. The loading sensor may be a force sensor that determines the weight of the objects held by the transport apparatus. The force sensor can also record wind loads, and the loading and the wind loads could add up to a critical load while driving. A loading threshold value to monitor the loading is stored in the control unit as well, and the sensor signals of the loading sensor are compared to the loading threshold value. If the sensor signal of the loading sensor exceeds the loading threshold value, a corresponding command is transmitted from the control unit to the motor vehicle control unit and the motor vehicle control unit triggers a corresponding measure.

The transport apparatus may comprise a surroundings sensor apparatus or a plurality of surroundings sensors, such as a camera and/or a radar unit attached on the motor vehicle. The surroundings sensor elements of the motor vehicle may be blocked by the transport apparatus, so that surroundings sensing and the resulting facilitation of driving is no longer possible. However, the transport apparatus that has an independent surroundings sensor apparatus connected in a signal-related manner to the motor vehicle control unit via the control unit, enables the blocked surroundings sensor elements of the motor vehicle to be replaced by the surroundings sensor apparatus. Thus, surroundings sensing and driving assistance are possible, even with a transport apparatus attached on the motor vehicle. The surroundings sensor apparatus may comprise at least one distance sensor and/or a camera apparatus. The distance sensor can, e.g., be an ultrasonic sensor or a radar sensor.

An arrangement comprising a motor vehicle and a transport apparatus attachable on said motor vehicle also is provided and reduces the risk of injury for the vehicle occupants and other road users by continuously monitoring the attachment and loading of the transport apparatus.

An exemplary embodiment of the invention is explained in further detail with reference to the drawing.

### BRIEF DESCRIPTION OF THE DRAWING

FIG. 1 is a schematic side view of a vehicle with a transport apparatus according to one embodiment.

### DETAILED DESCRIPTION

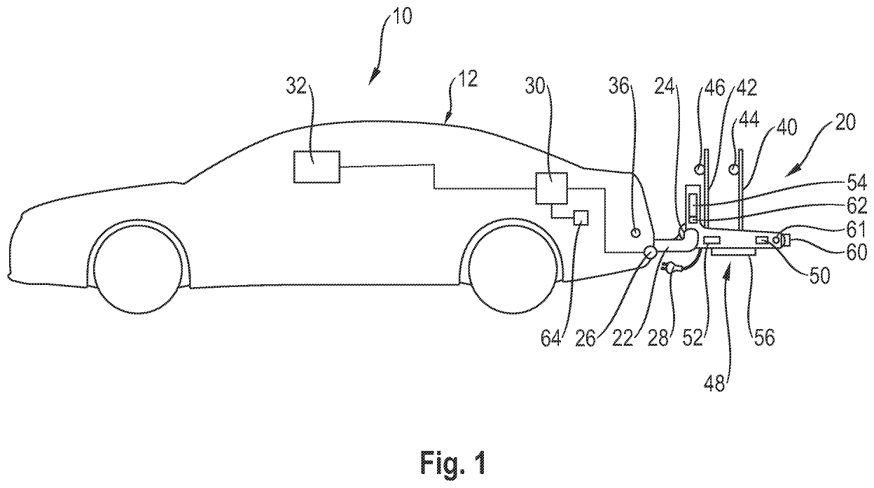

FIG. 1 shows an arrangement 10 comprising a motor vehicle 12 and a transport apparatus 20. The transport apparatus 20 is designed as a bicycle rack and is arranged on a rear region of the motor vehicle 12. More particularly, the transport apparatus 20 is attachable on the motor vehicle 12 as needed and removed if no transport is planned. The transport apparatus 20 is attached via an attachment apparatus 24 that may be part of a trailer hitch 22 of the motor vehicle 12. The attachment apparatus 24 may be configured in a known manner and may be configured to be placed on a ball head of the trailer hitch 22 and then fixed to the trailer hitch 22 when attaching the transport apparatus 20. The transport apparatus 20 comprises two bicycle holders 40, 42, each of which has a clamping apparatus 44, 46 for fixing one respective bicycle. The transport apparatus 20 also could be a transport container, e.g., a roof box or a container arranged in the rear or front region. The transport container is attachable on the trailer hitch 22, on a lift gate, on a roof transport system, or on a transport system attached directly on the bodyshell, e.g. on the cross member. The transport apparatus 20 also can be a trailer.

Power can be supplied to the transport apparatus 20 by a cable 28 that can be connected to a vehicle electrical system of the motor vehicle 12 via a motor vehicle interface 26. The transport apparatus 20 also comprises a battery 56 that can be charged by the vehicle electrical system and enables use of the transport apparatus 20 even without a connection to the vehicle electrical system.

The transport apparatus 20 is attached manually by one person, and the attachment of the transport apparatus 20 on the motor vehicle 12 and the loading of the transport apparatus 20 with objects is based solely on the experience of the respective person. Incorrect loading and attachment of the transport apparatus 20 when the motor vehicle 12 is driving poses a relatively high risk of injury to the vehicle occupants and other road users, especially if the transport apparatus 20 breaks loose from the motor vehicle 12. A dangerous situation also could arise with proper attachment and loading of a defective transport apparatus 20.

Accordingly, the transport apparatus 20 comprises a sensor apparatus 48 connected to a control unit 54 in a signal-related manner. The sensor apparatus 48 and the control unit 54 are connected respectively to the battery 56, and thus can be supplied with electrical energy by the battery 56.

The sensor apparatus 48 comprises an acceleration sensor 50 and a loading sensor 52 that are connected respectively to the control unit 54 in a signal-related manner. The control unit 54, in turn, is connected to a motor vehicle control unit 30 via the cable 28 and the motor vehicle interface 26 in a signal-related manner. The transport apparatus 20 also comprises a vehicle communication module 62 that can be connected wirelessly to a counter communication module 64, so that the control unit 54 and the motor vehicle control unit 30 can communicate wirelessly with one another as well. This is necessary if there is no motor vehicle interface 26, in which case the sensor apparatus 48 and the control unit 54 are supplied with electrical energy by the battery 56.

The motor vehicle control unit 30 and/or the control unit 54 of the transport apparatus 20 may be a computer and accordingly comprises one or more general-purpose processors (CPUs) or microprocessors, RISC processors, GPUs and/or DSPs. Thus, the motor vehicle control unit 30 and/or the control unit 54 of the transport apparatus 20 may have additional elements such as storage interfaces of the communication interfaces. Optionally or additionally, the terms refer to a device that is capable of executing a provided or included program, preferably with standardized programming language (for example C++, JavaScript or Python), and/or of controlling and/or accessing data storage devices and/or other devices such as input interfaces and output interfaces. The term computer also refers to a multiplicity of processors or a multiplicity of (sub)computers that are interconnected and/or connected and/or otherwise communicatively connected and possibly share one or more other resources, such as for example a memory.

A memory is for example a hard disk (HDD) or a (nonvolatile) solid state memory, for example a ROM store or flash memory [flash EEPROM]. The memory often comprises a plurality of individual physical units or is distributed over a multiplicity of separate devices, as a result of which access thereto takes place via data communication, for example package data service.

The purpose of the sensor apparatus 48 and the control unit 54 is that, when the transport apparatus 20 is attached on the motor vehicle 12, a plurality of state variables of the transport apparatus 20, i.e. the accelerations and the loading, are continuously acquired and the acquired state variables are monitored by the control unit 54 with respect to an attachment-critical and/or loading-critical state of the transport apparatus 20. The accelerations, in particular the vibrations, of the transport apparatus 20 are detected by the acceleration sensor 50, which preferably is a multiaxial acceleration sensor. The loading of the transport apparatus 20 is detected by the loading sensor 52. The loading sensor 52 may comprise a load cell. The detection of a deformation of a predefined component or the displacement of two components relative to one another is enabled by the loading sensor 52. More particularly, there is a direct relationship between the deformation or displacement and the loading, i.e. the force acting on the transport apparatus 20 as a result of the loading, so that the loading can be inferred from the detection of the deformation, the displacement and/or the vibration frequency. The sensor signals from the sensor apparatus 48 are evaluated by the control unit 54 and compared with predefined threshold values. If one of the threshold values is exceeded, then information about a critical state, e.g. overloading, is transmitted to the motor vehicle control unit 30, and a warning is transmitted via the motor vehicle control unit 30 to a display 32 visible to the driver.

The attachment and loading state of the transport apparatus 20 can thus be monitored continuously and a warning of a critical situation can be issued to the driver.

The transport apparatus 20 also comprises a surroundings sensor apparatus 60. The motor vehicle 12 comprises a plurality of ultrasonic sensors 36 to monitor the vehicle surroundings. Some of the ultrasonic sensors 36 are arranged in the rear region and are intended to make reversing easier for the driver. Attaching the transport apparatus 20 on the trailer hitch 22, i.e. in the rear region, may causes the ultrasonic sensors 36 to be blocked by the transport apparatus 20. To provide surroundings monitoring even when the transport apparatus 20 is attached on the motor vehicle, the transport apparatus 20 comprises the surroundings sensor apparatus 60 with a plurality of ultrasonic sensors 61. Sensor signals from the surroundings sensor apparatus 60 are transmitted to the counter communication module 64 or the motor vehicle control unit 30 in a wired manner via the motor vehicle interface 26 and/or via the control unit 54 or wirelessly via the vehicle communication module 62. Thus, when the transport apparatus 20 is attached, the no longer usable ultrasonic sensors 36 are replaced by the surroundings sensor apparatus 60.

A transport apparatus 20 can thereby be provided, by means of which safe driving of the motor vehicle 12 can be ensured.

1. An arrangement comprising:
a motor vehicle (12) having a motor vehicle control unit (30); and
a transport apparatus (20) attachable on the motor vehicle (12), the transport apparatus (20) comprising a sensor apparatus (48) and a control unit (54) that is connected to the motor vehicle control unit (30) in a signal-related manner, the sensor apparatus (48) and the control unit (54) being designed such that the sensor apparatus (48) acquires at least one state variable of the transport apparatus (20) in an attached state on the motor vehicle (12), and the at least one acquired state variable is monitored by the control unit (54) with respect to an attachment-critical and/or loading-critical state of the transport apparatus (20).

2. The arrangement of claim 1, wherein the transport apparatus (20) is connectable in a signal-related manner to the motor vehicle (12) via a cable (28).

3. The arrangement of claim 1, wherein the transport apparatus (20) comprises a vehicle communication module (62) wirelessly connectable to a counter communication module (64) of the motor vehicle arranged on the motor vehicle (12)

4. The arrangement of claim 1, wherein the control unit (54) is arranged on the transport apparatus (20).

5. The arrangement of claim 1, wherein the control unit (54) is integrated into the motor vehicle control unit (30).

6. The arrangement of claim 1, wherein the transport apparatus (20) is electrically connectable to a vehicle electrical system of the motor vehicle (12).

7. The arrangement of claim 1, wherein the transport apparatus (20) comprises a battery (56) electrically connected to the sensor apparatus (48).

8. The arrangement of claim 1, wherein the sensor apparatus (48) comprises an acceleration sensor (50) for detecting vibrations of the transport apparatus (20).

9. The arrangement of claim 8, wherein the sensor apparatus (48) comprises a loading sensor (52).

10. The arrangement of claim 9, wherein the transport apparatus (20) comprises a surroundings sensor apparatus (60).

11. The arrangement of claim 10, wherein the surroundings sensor apparatus (60) comprises at least one distance sensor (61).

12. The arrangement of claim 11, wherein the surroundings sensor apparatus (60) comprises at least one camera apparatus.

13. The arrangement of claim 1, wherein the sensor apparatus (48) comprises a loading sensor (52).

14. The arrangement of claim 1, wherein the transport apparatus (20) comprises a surroundings sensor apparatus (60).

15. The arrangement of claim 14, wherein the surroundings sensor apparatus (60) comprises at least one distance sensor (61).

16. The arrangement of claim 14, wherein the surroundings sensor apparatus (60) comprises at least one camera apparatus.
